(19) United States
(12) Patent Application Publication
(10) Pub. No.: US 2014/0105316 A1
(43) Pub. Date: Apr. 17, 2014

(54) METHOD AND SYSTEM FOR SPATIAL CHANNEL STATE INFORMATION FEEDBACK FOR MULTIPLE-INPUT MULTIPLE-OUTPUT (MIMO)

(71) Applicants: Yifei Yuan, Morristown, NJ (US); David Huo, Morristown, NJ (US)

(72) Inventors: Yifei Yuan, Morristown, NJ (US); David Huo, Morristown, NJ (US)

(73) Assignee: ZTE Corporation, Shenzhen (CN)

(21) Appl. No.: 14/113,355

(22) PCT Filed: Apr. 18, 2012
(86) PCT No.: PCT/US12/33990

§ 371 Date: Dec. 30, 2013

Related U.S. Application Data
(60) Provisional application No. 61/479,123, filed on Apr. 26, 2011.

(51) Int. Cl. H04B 7/04; H04L 25/03; H04L 25/02

(52) U.S. Cl. CPC H04B 7/0417; H04L 25/0248; H04L 25/03955
USPC 375/260

(57) ABSTRACT

A method and system for feedback of spatial CSI of a spatial channel that connects receive antennas at user equipment and multiple transmit antennas. Spatial discrimination information is provided as feedback at the transmitter and the receiver connecting the user equipment and a cell. With the user equipment providing the transmitter and the receiver side spatial discrimination information of each sub-channel as feedback, the composite spatial CSI over multiple segments of transmit antennas can be determined. The user equipment may have one or multiple receiving antennas, and the spatial discrimination information can be subband short-term. In some embodiments, the spatial discrimination information at the receiver side is derived from the actual spatial channel while receiver implementation is taken into account. The spatial discrimination information at the transmitter and at the receiver can be can be provided as feedback using codebooks for MIMO precoding.

### BACKGROUND 1. Field of the Invention

The field of the present invention relates to feeding back spatial channel state information (CSI) for downlink MIMO technologies. Specifically, the field of the invention relates to spatial CSI feedback using element-wise quantization on eigenvectors.

2. Background of the Invention

MIMO technologies can significantly improve data throughput at the link level, at the system level, or at both the link level and the system levels. Spatial multiplexing and beamforming have been used to enhance spectral efficiency and data throughput. Spatial multiplexing directly boosts the link level throughput and the peak rate by multiplexing data streams to the same user via parallel channels. Spatial multiplexing is most effective when spatial correlation between antennas is low, both for the transmit antennas and the receive antennas. Beamforming or precoding increases the signal-to-interference-plus-noise ratio (SINR) of the channel and thus the channel rate. Precoding refers to applying transmission weights over multiple antennas, where the weight calculations are based on CSI either from channel reciprocity or feedback.

When the number of transmit antennas is greater than the number of receive antennas, the extra spatial dimensions at the transmitter favor precoding, although spatial multiplexing can still be carried out as long as the rank of channel is greater than one. In frequency-division duplexing (FDD) systems, where channel reciprocity does not generally hold, spatial CSI feedback is needed for the precoding. Due to overhead concern, CSI feedback cannot utilize too many bits. In general, as the number of bits increases, the quantization error decreases.

Precoded MIMO can operate in two scenarios: single user MIMO (SU-MIMO) and multi-user MIMO (MU-MIMO). In SU-MIMO, the spatially multiplexed streams are transmitted to one user and the precoding is primarily used to increase the SINR at the receiver. In MU-MIMO, data streams of multiple users share the same set of transmit antennas in the same time-frequency resource. Data decoupling is achieved by appropriate precoding and receiver processing. The quantization error in spatial CSI feedback affects the performance of SU-MIMO and MU-MIMO quite differently, however. For SU-MIMO, the finite resolution of codebooks results in certain SINR loss when the precoding does not perfectly match the spatial characteristics of the MIMO channel. Such SINR loss is almost uniform across different signal-to-noise (SNR) operating regions, at either low or high SNR regions. In other words, there is no loss in spatial multiplexing since the decoupling of multiple streams to the same user is solely done at the receiver, which has nothing to do with the precoding at the transmitter. However, for MU-MIMO, the quantization error gives rise to cross-user interference, which quickly saturates the MIMO channel rate as SNR increases, as seen in FIG. 1 and described in 3GPP R1-093818, “Performance sensitivity to feedback types”, ZTE, RAN1#58bis, Miyazaki, Japan, October 2009.

When the antennas at the transmitter are correlated (e.g., beamforming antennas), codebook design problems can be significantly reduced as the MIMO channel characteristics are degraded to linear phase rotations. However, the codebook design for an uncorrelated channel is generally difficult if it is constrained by the number of bits affordable for the CSI feedback. One typical configuration of uncorrelated antennas is widely-spaced cross-pols. In a scattering environment, the spacing between the two sets (usually >4 wavelengths) ensures low correlations in between. The orthogonal polarizations (+45/−45 degrees) results in rather independent fading in each polarization direction.

Information theory, as described in N. Jindal, “MIMO broadcast channels with finite-rate feedback,” IEEE Transactions on Information Theory, vol. 52, no. 11. November 2006, pp. 5045-5060, shows that in order to achieve the full multiplexing gain in MU-MIMO, the required number of bits for CSI quantization per user should be proportional to the operating SNR in dBs as follows

$$B = ( M - 1 ) {log}_{2} P \approx \frac{M - 1}{3} {P}_{d B} \qquad ( 1 )$$

where M is the number of transmit antennas.

In 4G wireless systems, mobile terminals are supposed to have two receive antennas, which means that for effective precoding, M should be equal to or greater than four. Even at M=4, the required number of bits needs to increase by 1 dB when the SNR operating point moves 1 dB higher. If B=2 bits at low SNR (i.e., <3 dB), B can go beyond 15 bits for high SNR (i.e., >16 dB). Design and storage of such a big codebook (2¹⁵=32798 entries) is challenging, and the codeword search would require significant baseband processing. This and other circumstances present problems and obstacles that are overcome by the methods and systems described below.

### SUMMARY OF THE INVENTION

The present invention is directed to wireless communication methods and systems which provide spatial CSI for downlink MIMO technologies using element-wise quantization on eigenvectors.

In the method, spatial CSI for uncorrelated MIMO channels is provided as feedback from user equipment to transmitting equipment. More particularly, spatial CSI is estimated at user equipment then decomposed into eigenvectors. The elements of the eigenvectors are quantized and used as feed back to the transmitting equipment. The quantization is in amplitude and phase and may be normalized beforehand. Optionally, codebooks may be used for the feedback. The eigenvectors may also be reconstructed from the feedback and a precoding matrix may be calculated at the transmitting equipment.

The system includes means for estimating spatial CSI at user equipment, means for decomposing the spatial CSI into eigenvectors, means for quantizing the eigenvectors, and means for providing the quantized eigenvectors as feedback to transmitting equipment. The quantizer is configured to quantize in amplitude and phase. Moreover, means for normalizing the amplitude and phase may be included. Optionally, the transmitting equipment may include means for reconstructing eigenvectors from quantized elements and means for calculating a precoding matrix.

Additional aspects and advantages of the improvements will appear from the description of the preferred embodiment.

### BRIEF DESCRIPTION OF THE FIGURES

Embodiments of the present invention are illustrated by way of the accompanying drawings.

FIG. 1 shows the performance sensitivity of precoded MIMO to CSI feedback.

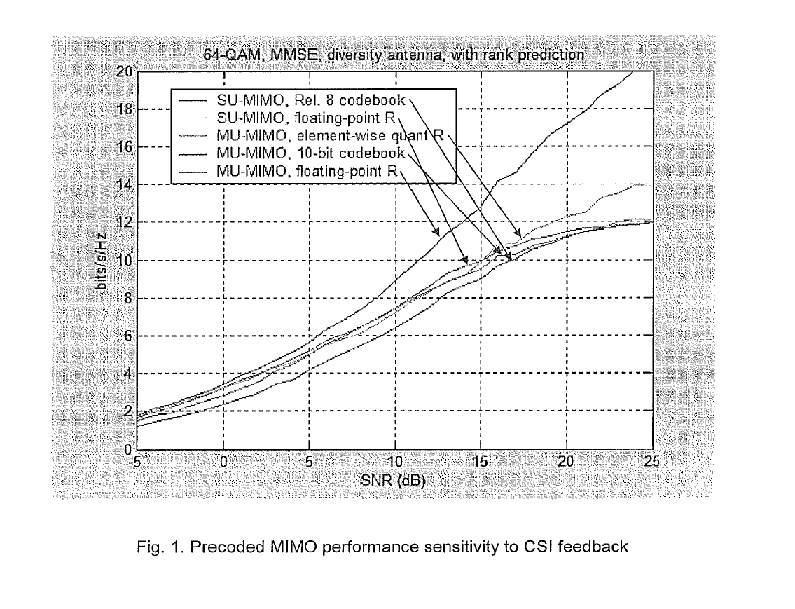

FIG. 2 shows the performance benefit of element-wise quantizing of the eigenvectors over quantizing the covariance matrix.

FIG. 3 is a block diagram of an example of spatial CSI feedback for downlink MIMO.

FIG. 4 illustrates an example of transmit antenna segmentation.

### DETAILED DESCRIPTION OF THE PREFERRED EMBODIMENTS

The method and system described below provide an efficient way to accurately feedback the spatial CSI for uncorrelated MIMO channels, particularly when the number of MIMO rank per user is equal to or greater than two. The method and system is applicable to mobiles with single or multiple receiving antennas.

The spatial discrimination information at the receiver side for each segment of transmit antennas can be derived directly from the spatial channel (explicit feedback), for example by singular value decomposition (SVD), or taking into account receiver implementation (implicit feedback). Implicit feedback assumes certain receiver processing and usually takes the form of a precoding matrix indicator (PMI) or the enhanced versions. Explicit feedback attempts to “objectively” capture the spatial channel characteristics without taking into account the receiver processing. The spatial channel is measured from the reference channels for channel state information (CSI-RS). CSI-RS is configured by higher layers.

Spatial CSI can be used as feedback using codebooks. A codebook is effectively a vector quantizer. Codebooks of earlier LTE releases, e.g., Rel-8/9/10, may be reused. SNR related information such as eigenvalues of the spatial channel can be used as feed back using Rel-8/9/10 CQI, or the enhancements.

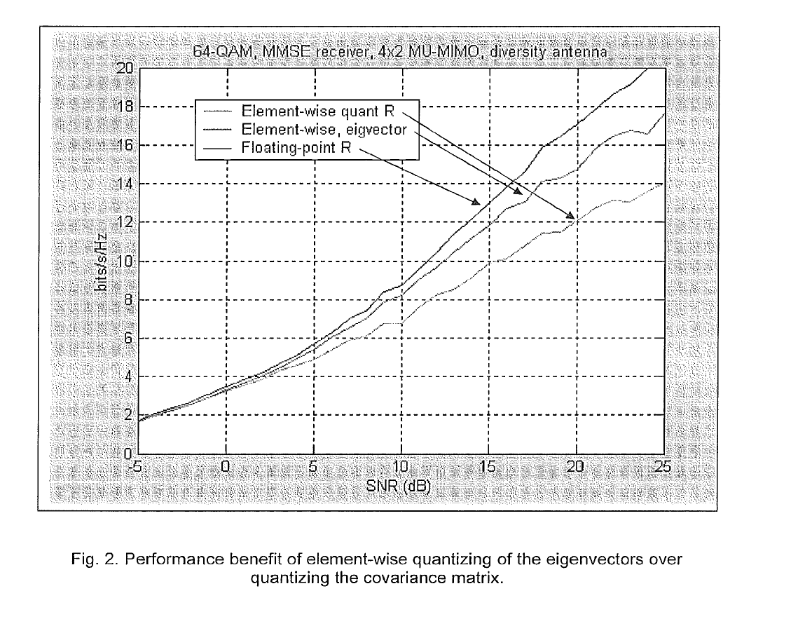

In 3GPP R1-094844, “Low-overhead feedback of spatial covariance matrix”, Motorola, RAN1#59, Jeju, Korea, November 2009, spatial CSI is characterized by transmit covariance matrix, and the quantization is done element-by-element. In contrast, here, spatial CSI may be represented by the eigenvectors and the quantization may be done on each element of the eigenvectors. As a result, more accurate CSI feedback can be achieved with less number of bits, as seen in FIG. 2.

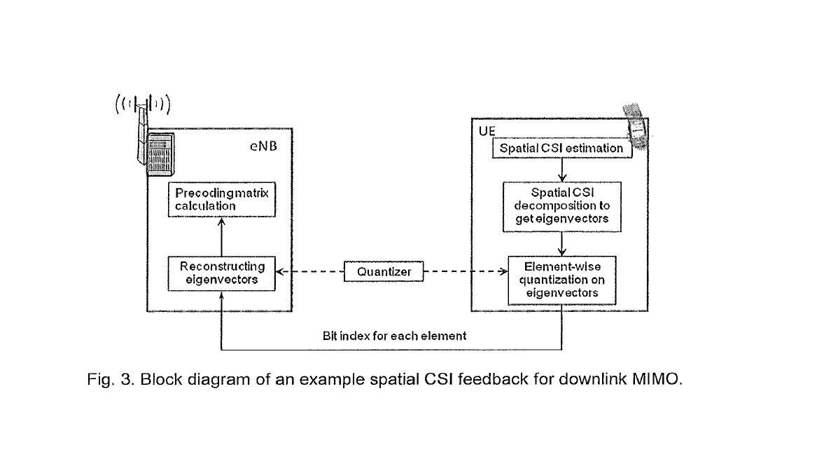

FIG. 3 illustrates an example of a feedback setup wherein eigenvectors are quantized element-by-element. There are two major entities in the setup, namely, evolved nodeB (eNB) and user equipment (UE). The transmit antennas of eNB can reside in different geographic locations and have different polarizations.

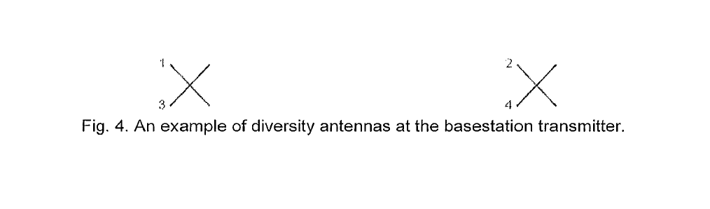

FIG. 4 illustrates a diversity antenna configuration of widely spaced cross-polarization antennas (a total of four elements) at the basestation. Assuming the mobile terminal has two receive antennas, the four-by-two MIMO channel H is segmented as

$$H = [ \begin{matrix}{h}_{11} & {h}_{12} \\ {h}_{21} & {h}_{22} \\ {h}_{31} & {h}_{32} \\ {h}_{41} & {h}_{42}\end{matrix} ] \qquad ( 2 )$$

where the second subscripts (1, 2) of “h” in (2) are the indices of the receive antennas. For an uncorrelated channel, each element in H is uniformly distributed.

After H is estimated at the receiver, singular value decomposition (SVD) is carried out to get the eigenvectors:

$$H = V Λ U = [ \begin{matrix}{v}_{11} & {v}_{12} & {v}_{13} & {v}_{4} \\ {v}_{21} & {v}_{22} & {v}_{23} & {v}_{24} \\ {v}_{31} & {v}_{32} & {v}_{33} & {v}_{34} \\ {v}_{41} & {v}_{42} & {v}_{43} & {v}_{44}\end{matrix} ] [ \begin{matrix}{λ}_{11} & 0 \\ 0 & {λ}_{12} \\ 0 & 0 \\ 0 & 0\end{matrix} ] [ \begin{matrix}{u}_{11} & {u}_{12} \\ {u}_{21} & {u}_{22 }\end{matrix} ] \qquad ( 3 )$$

Matrix V represents the transmitter side spatial discrimination, which is relevant for precoding. In fact, only the first two columns of V are useful for precoding if the MIMO rank is two per user. If the eigenvalue of the second column vector is too small, however, the MIMO rank becomes one, and only the first column vector is needed for precoding. The eigenvectors in V can also be determined via other methods as long as those other methods capture the transmitter side spatial discrimination characteristics.

For an uncorrelated channel, a uniform quantizer is used for each element of the first and the second columns of V. Because those elements are generally complex numbers, the quantization is done in amplitude and phase, separately. To facilitate the quantization, amplitude and phase normalization can be carried out first. Such normalization does not change the fundamental nature of the spatial CSI and does not affect the precoder calculation at the transmitter.

The amplitude is normalized by the largest amplitude element. After the amplitude normalization, seven thresholds can be used, e.g., [0.25, 0.35, 0.45, 0.55, 0.65, 0.75, 0.85] to get eight (three-bit) quantized values [0.2, 0.3, 0.4, 0.5, 0.6, 0.7, 0.8, 0.925]. For the phase, the elements in each column can be normalized by the phase of the first row element, so that the first row elements become real numbers. In such case, only three bits is needed for the quantization. [−π, π] phases can be quantized to one of 32 bins (each of π/2).

While embodiments of the methods and systems have been shown and described, it will be apparent to those skilled in the art that many more modifications are possible without departing from the inventive concepts herein. The invention, therefore, is not to be restricted except in the spirit of the following claims.

1. A spatial CSI feedback method for uncorrelated MIMO channels, the method comprising:
estimating spatial CSI at user equipment (UE);
decomposing the spatial CSI, resulting in eigenvectors comprising elements;
quantizing the elements; and
providing the quantized elements as feedback.

2. The method of claim 1, wherein quantizing the elements includes quantizing the elements in amplitude and phase.

3. The method of claim 2, further comprising normalizing the amplitude and the phase.

4. The method of claim 3, wherein normalizing the amplitude and the phase includes normalizing the amplitude by a largest amplitude element and normalizing the phase by a first row element.

5. The method of claim 1, wherein decomposing the spatial CSI includes singular value decomposition.

6. The method of claim 1, wherein quantizing the elements includes quantizing the elements using a uniform quantizer.

7. The method of claim 1, wherein the spatial CSI at the UE comprises a matrix having two or more columns representing transmitter side spatial discrimination, and the elements comprise the elements of one of the first column or the first and the second columns.

8. The method of claim 1, wherein the spatial CSI accounts for receiver implementation.

9. The method of claim 1, wherein the spatial CSI is short-term subband.

10. The method of claim 1, wherein providing the quantized elements as feedback comprises using one or more codebooks for MIMO precoding.

11. The method of claim 1, further comprising:
reconstructing eigenvectors from quantized elements; and
calculating a precoding matrix.

12. A spatial CSI feedback system for uncorrelated MIMO channels, the system comprising:
means for estimating spatial CSI at user equipment (UE);
means for decomposing the spatial CSI, resulting in eigenvectors comprising elements;
means for quantizing the elements; and
means for providing the quantized elements as feedback.

13. The system of claim 12, wherein the means for quantizing the elements is configured to quantize in amplitude and phase.

14. The system of claim 13, further comprising means for normalizing the amplitude and the phase.

15. The system of claim 14, wherein the means for normalizing is configured to normalize the amplitude by a largest amplitude element and normalize the phase by a first row element.

16. The system of claim 12, wherein the means for decomposing is configured for singular value decomposition.

17. The system of claim 12, wherein the means for quantizing is a uniform quantizer.

18. The system of claim 12, wherein the spatial CSI at the UE comprises a matrix having two or more columns representing transmitter side spatial discrimination, and the elements comprise the elements of one of the first column or the first and the second columns.

19. The system of claim 12, wherein the spatial CSI accounts for receiver implementation.

20. The system of claim 12, wherein the spatial CSI is short-term subband.

21. The system of claim 12, wherein the means for providing the quantized elements as feedback is configured to use one or more codebooks for MIMO precoding.

22. The system of claim 12, further comprising:
means for reconstructing eigenvectors from quantized elements; and
means for calculating a precoding matrix.
